(19) United States
(12) Patent Application Publication
(10) Pub. No.: US 2024/0043585 A1
(43) Pub. Date: Feb. 8, 2024

(54) HYDROPHOBIC POLYOLS WITH ENHANCED HEAT RESISTANCE AND DUST CONTROL FOR FIBROUS MATERIALS

(71) Applicant: JOHNS MANVILLE, Denver, CO (US)

(72) Inventors: Kiarash Alavi, Littleton, CO (US); Ameya Natu, Highlands Ranch, CO (US); Uranchimeg Lester, Littleton, CO (US); James Cottier, Red Bluff, CA (US); Jawed Asrar, Englewood, CO (US)

(21) Appl. No.: 17/880,407

(22) Filed: Aug. 3, 2022

(51) Int. Cl. C08F 120/06; C08G 59/16; C08G 59/50; C08G 59/68; C08J 3/24; C08J 5/04; D04H 1/4218; D04H 1/587; D04H 1/64

(52) U.S. Cl. CPC C08F 120/06; C08G 59/1472; C08G 59/5006; C08G 59/686; C08G 59/688; C08J 3/24; C08J 5/043; D04H 1/4218; D04H 1/587; D04H 1/64; C08G 2330/00

(57) ABSTRACT

Binder compositions for fiberglass are disclosed, comprising a polycarboxylic acid such as polyacrylic acid and a crosslinking agent. The crosslinking agent comprises a polyhydroxy component formed from a reaction of an epoxidized plant oil with an amine and optionally with a phenolic compound. The molar ratio of the amine to the epoxidized plant oil at the beginning of said reaction may be greater than 1:1. Methods of making the binders and fiber-containing composites made with said binders are also described.

### FIELD OF THE INVENTION

The invention relates to binder compositions for fiberglass and to processes for making same. The binder compositions comprise a polycarboxylic acid such as polyacrylic acid and a crosslinking agent comprising a polyhydroxy component formed from a reaction of an epoxidized plant oil with an amine.

### BACKGROUND OF THE INVENTION

Thermoset binders for fiberglass composite products such as fiberglass insulation are moving away from traditional formaldehyde-based compositions. Formaldehyde is considered a probable human carcinogen, as well as an irritant and allergen, and its use is increasingly restricted in building products, textiles, upholstery, and other materials. In response, binder compositions have been developed that do not use formaldehyde or decompose to generate formaldehyde.

Various formaldehyde free binders for glass, mineral and organic fibers (natural and synthetic) have been described in the literature and used for many years. One class of such binders is based on polyacrylic acid that is crosslinked with low molecular weight polyols such as triethanol amine, glycerol, or sorbitol. Other binders are based on condensation of low molecular weight polycarboxylic acids such as citric acid with polyols such as starch or maltodextrin. These polymers have been commercialized since late 1990s for the fiber glass insulation industry.

The most common polycarboxylic acid used in these applications is polyacrylic acid (PAA) with a molecular weight (Mw) of 1000-5000 and triethanol amine (TEA) as crosslinker. Rohm & Haas (DOW Chemical) developed a PAA/TEA system in the early 1990s, and Johns Manville, Owens Corning, and others have filed many patent applications in the field as well. In addition to TEA, many polyols are mentioned in the literature without paying attention to the pyrolysis and thermal degradation of polyols/PAA. U.S. Pat. No. 6,933,349 describes binder based on low Mw PAA prepared using phosphorus-based chain transfer agent and crosslinked with TEA or glycerol as polyols. U.S. Pat. Nos. 6,331,350 and 6,136,916 describe binders based on PAA with polyols. U.S. Pat. No. 10,988,643 teaches the use of citric acid and starch binder for insulation products.

Although these polymers provide mechanical performance of the insulation products that are comparable with phenol-formaldehyde (PF) resins, hydrolylic stability (moisture resistance) and thermal resistance of these polymers are not comparable with PF resins. A drawback of the polycarboxylic acid/polyol binders for fibrous materials is that due to relatively low binder content of the fibrous articles, usually 2-20% loss on ignition (LOI), and the high specific surface area of the fibers, the cured binders have relatively high sensitivity to environmental conditions. The crosslinking mechanism for these binders is based on the reaction of hydroxyl groups with carboxylic acid groups resulting in the formation of ester linkages. Exposure of cured binder to water, e.g., through atmospheric moisture, coupled with the high surface area of the exposed binder to the environment can result in hydrolysis of the ester linkages causing reduction in the humid aged retention of the fibrous materials. The need exists for binders having improved humid aged retention.

In addition to improved humid aged retention, high thermal resistance is generally desired for applications such as pipe insulation, aerospace insulation, liner and boards, and other high density products where the product is subject to temperatures greater than 230° C. When these products are heated to greater than 230° C., many binders can decompose exothermically generating volatile organic compounds (VOCs) due to their generally high resin content (typically 12-22 wt. % for liner and boards and 6 wt. % for pipe) and high density. These VOCs get trapped inside of the fiber matrices. When the concentration of the VOCs reaches a certain level, the material can ignite causing a fire. Similar phenomena have been observed with low density products where LOI is as low as 4 wt. %.

During the production of building insulation, clumps of binder-rich fiber can be formed. These clumps can have binder LOI as high as 50%. If these clumps pass through the curing ovens undetected, fires can result. In addition to fire danger, the polyol/poly carboxylic systems generally have higher cure temperatures than PF. To ensure complete curing of PAA-based binder systems, oven temperatures typically need to be increased from 220° C. to 270° C. As a result, elevated fume levels may be generated in the ovens resulting in the need for personnel, equipment, and environmental protection. It is apparent that the combination of high LOI and higher curing temperature for PAA/polyol binder systems along with the process imperfections such as formation of high LOI clumps dictates the need for binder systems having higher thermal stability and lower VOC generation.

Another problem encountered during fiberglass manufacture is controlling dust formed from normal fiber breakage. Dust control of fibrous materials including fiberglass insulation can be achieved by addition of an external dedusting oil. These oils are conventionally either petroleum based with high-boiling points or based on oxidized/oligomerized plant oils. Both oils tend to migrate to the surface of cured binder on the fibrous material, forming a thin layer of oil. These oils, however, can increase flammability particularly in curing ovens. Thus, the need also exists for dust-controlling agents having enhanced exotherm resistance but that can react with the binder forming permanent chemical bonds with the resin. Additionally, the need exists for dust control agents having higher thermal stability. These and other issues are disclosed in the present specification.

### BRIEF SUMMARY OF THE INVENTION

In one embodiment, a binder composition for fiberglass is disclosed, comprising a polycarboxylic acid, e.g., polyacrylic acid, and a crosslinking agent. The crosslinking agent comprises a polyhydroxy component derived from epoxidized plant oil, preferably formed from a reaction of an epoxidized plant oil with an amine, wherein the molar ratio of the amine to the epoxidized plant oil at the beginning of said reaction optionally is greater than 0.5:1, e.g., greater than 0.75:1, greater than 1:1, greater than 2:1, or greater than 3:1. In terms of ranges, the molar ratio of the amine to the epoxidized plant oil to at the beginning of said reaction may range from 1:1 to 3.6:1, 1.5 to 3.0, or 1.7 to 2.3.

The inventive polyhydroxy component may also be employed as a crosslinking agent or a dedusting agent for formaldehyde-based binders or formaldehyde-free binders. For example, in one aspect a binder composition for fiberglass is disclosed, comprising a formaldehyde-based binder and a crosslinking agent, wherein the crosslinking agent comprises a polyhydroxy component derived from epoxidized plant oil, wherein the polyhydroxy component is formed from a reaction of an epoxidized plant oil with an amine and optionally with a phenolic compound. The formaldehyde-based binder optionally may be selected from the group consisting of a phenol-formaldehyde based binder, a urea-formaldehyde based binder, a melamine-formaldehyde based binder, and any combination thereof. In another aspect, a binder composition for fiberglass is disclosed, comprising a formaldehyde-free binder and a crosslinking agent, wherein the crosslinking agent comprises a polyhydroxy component derived from epoxidized plant oil, wherein the polyhydroxy component is formed from a reaction of an epoxidized plant oil with an amine and optionally with a phenolic compound. In this aspect, the formaldehyde-free binder optionally may be selected from the group consisting of a polyesters, melanoidin-based resin, epoxy resin, acrylic resin, polyurethanes, and any combination thereof.

In another embodiment, a method of forming a binder composition for fiberglass is disclosed. The method comprises reacting an epoxidized plant oil with an amine optionally in the presence of a catalyst to form a polyhydroxy crosslinking agent. The molar ratio of the amine to the epoxidized plant oil at the beginning of said reacting step is greater than 0.5:1, e.g., greater than 0.75:1, greater than 1:1, greater than 2:1, or greater than 3:1. The method further comprises mixing said polyhydroxy crosslinking agent with a polymer, e.g., polyacrylic acid, to form the binder composition.

In another embodiment, a crosslinkable binder composition for fiberglass is disclosed. The crosslinkable binder comprises a mixture of at least (i) a crosslinkable polyacrylic acid, and (ii) a dedusting agent. The dedusting agent comprises a polyhydroxy component formed from a reaction of an epoxidized plant oil with an amine, and the molar ratio of the amine to the epoxidized plant oil at the beginning of said reaction is greater than 0.5:1, e.g., greater than 0.75:1, greater than 1:1, greater than 2:1, or greater than 3:1.

In another embodiment, a fiber-containing composite is disclosed, comprising (a) woven or non-woven fibers; and (b) a cured binder that holds the fibers together. The binder comprises a polyacrylic acid crosslinked by a crosslinking agent. The crosslinking agent comprises a polyhydroxy component formed from a reaction of an epoxidized plant oil with an amine, wherein the molar ratio of the amine to the epoxidized plant oil at the beginning of said reaction is greater than 0.5:1, e.g., greater than 0.75:1, is greater than 1:1, greater than 2:1, or greater than 3:1.

In another embodiment, a binder composition for fiberglass is disclosed. The binder comprises a polycarboxylic acid, e.g., polyacrylic acid, and a crosslinking agent. The crosslinking agent comprises a polyhydroxy component formed from a reaction of an epoxidized plant oil with a phenolic compound and an amine.

In another embodiment, a method of forming a binder composition for fiberglass is disclosed. The method comprises reacting an epoxidized plant oil with a phenolic compound and an amine optionally in the presence of a catalyst to form a polyhydroxy crosslinking agent. The method further comprises mixing the polyhydroxy crosslinking agent with a polymer, e.g., polyacrylic acid, to form the binder composition. As with the previously described embodiments, the molar ratio of the amine to the epoxidized plant oil at the beginning of said reaction optionally ranges from 1:1 to 3.6:1, 1.5 to 3.0, or 1.7 to 2.3.

In another embodiment, a crosslinkable binder composition for fiberglass is disclosed. The crosslinkable binder composition comprises (i) a crosslinkable polyacrylic acid, and (ii) a dedusting agent. The dedusting agent comprises a polyhydroxy component formed from a reaction of an epoxidized plant oil with a phenolic compound and an amine.

In another embodiment, a fiber-containing composite is disclosed. The composite comprises (a) woven or non-woven fibers; and (b) a cured binder that holds the fibers together. The cured binder comprises a polyacrylic acid crosslinked by a crosslinking agent, wherein the crosslinking agent comprises a polyhydroxy component formed from a reaction of an epoxidized plant oil with a phenolic compound and an amine.

In each embodiment, the amine optionally comprises a monoalkanol amine, a dialkanol amine, a trialkanol amine, monoalkyl ethanol amine, a monoalkyl amine, a dialkyl amine, ammonia, or an ammonium salt of an organic acid or an inorganic acid. In other aspects, the amine optionally comprises monoethanol amine, diethanol amine, triethanol amine, butylamine, ethylenediamine, or hexamethylenediamine.

When the cross-linking agent is formed, inter alia, from a phenolic compound, the phenolic compound optionally is selected from the group consisting of monophenols such as phenol, cresol, t-butyl phenol, nonyl phenol, methylol phenol or from the group of diphenols such as catechol, resorcinol, hydroquinone or from the group of bisphenols such bisphenol A, bisphenol F, bisphenol S and polyphenolics. Thus, the phenolic compound optionally comprises phenol, cresol, t-butyl phenol, nonyl phenol, methylol phenol, catechol, resorcinol, hydroquinone, bisphenol A, bisphenol F, bisphenol S, or a polyphenolic.

The epoxidized plant oil optionally is selected from the group consisting of epoxidized soybean oil, epoxidized linseed oil, epoxidized safflower oil, epoxidized sunflower oil, epoxidized castor oil, and epoxidized tall oil fatty acid. In some aspects, the epoxidized plant oil comprises epoxidized soybean oil, the amine comprises diethanolamine, and the diethanolamine to the epoxidized soybean oil molar ratio is greater than 0.5:1, optionally from 1 to 4.3, or from 2.1 to 2.8.

The crosslinking agent may comprise the polyhydroxy component in an amount from 5 to 100 wt. %, based on total weight of the crosslinking agent. Thus, in various optional embodiments, the crosslinking agent may comprise: (i) the polyhydroxy component in an amount from 5 to 100 wt. %, e.g., from 5 to 25 wt. %, from 25 to 75 wt. %, or from 75 to 95 wt. %, and (ii) a secondary component in an amount from 0 to 95 wt. %, e.g., from 75 to 95 wt. %, from 25 to 75 wt. %, or from 5 to 25 wt. %, based on the total weight of crosslinking agent. When included, the secondary component optionally is a polyol selected from the group consisting of sorbitol, triethanolamine, diethanolamine, polyvinyl alcohol, glycerol, propylene glycol, neopentyl glycol, trimethylol propane, pentaerythritol, polyester polyol, and acrylic polyols. In this aspect, the mass ratio of polyhydroxy component to secondary component optionally is in the range of from 11:89 to 99:1, e.g., from 15:85 to 90:10, or from 30:70 to 70:30.

In optional embodiments, the reaction optionally occurs in the presence of a Lewis base catalyst such as tertiary amines comprising DABCO (1,4-diazabicyclo[2.2.2]octane) or triphenylphosphine (TPP) or alkali metal catalysts, such as sodium hydroxide (NaOH) or potassium hydroxide (KOH). In other embodiments, the reaction occurs in the substantial or complete absence of a catalyst.

In some aspects, the polycarboxylic acid, e.g., polyacrylic acid, has a Mw from 1000-100,000, e.g., from 2000-20,000.

In optional embodiments, the molar ratio of hydroxyl groups in the polyhydroxy component to carboxyl groups in said polycarboxylic acid ranges from 0.3:1 to 2:1, e.g., from 0.5:1 to 1.5:1. Thus, when the polycarboxylic acid is polyacrylic acid, the molar ratio of hydroxyl groups in the polyhydroxy component to carboxylic acid groups in said polyacrylic acid optionally ranges from 0.3:1 to 2:1, e.g., from 0.5:1 to 1.5:1. The phenolic compound and/or the amine may or may not be reacted in stoichiometric amounts. Preferably, less than 1 wt. % of the phenolic compound and less than 1.5% of the amine remain unreacted upon completion of the reaction.

In the fiber-containing composite embodiments, the composite optionally has an onset of exotherm greater than 279° C., e.g., greater than 300° C., or greater than 350° C. The corresponding dogbone composite, as defined herein, optionally has a humid aged dogbone tensile strength greater than 1.1 Megapascal (Mpa), e.g., greater than 1.3 MPa, or greater than 1.5 MPa as determined by a Tensile Testing Machine (Instron Corp., Norwood, MA, USA).

Additional embodiments and features are set forth in part in the description that follows, and in part will become apparent to those skilled in the art upon examination of the specification or may be learned by the practice of the invention. The features and advantages of the invention may be realized and attained by means of the instrumentalities, combinations, and methods described in the specification.

### BRIEF DESCRIPTION OF THE DRAWINGS

A further understanding of the nature and advantages of the present invention may be realized by reference to the remaining portions of the specification and the drawings wherein like reference numerals are used throughout the several drawings to refer to similar components. In some instances, a sublabel is associated with a reference numeral and follows a hyphen to denote one of multiple similar components. When reference is made to a reference numeral without specification to an existing sublabel, it is intended to refer to all such multiple similar components.

FIG. 1 is a graph showing the exotherm profile of a 40% LOI glass-wad of the DEA-ESO dedusting agent of Example 1 relative to a 40% LOI glass-wad of commercial dedusting oil.

FIG. 2 is a graph showing the exotherm profile of a 40% LOI glass-wad prepared using a commercial polyacrylic/polyol Resin-1 with 10% DEA-ESO dedusting agent of Example 1 relative to a 40% LOI glass-wad of a commercial polyacrylic/polyol Resin-1 with 10% commercial dedusting oil.

FIG. 3 is a graph showing the exotherm of a 40% LOI glass-wad of phenolic compound containing dedusting agents formed in Examples 5 and 10 relative to a 40% LOI glass-wad of a commercial dedusting oil.

FIG. 4 is a graph showing the exotherm profile of a 40% LOI glass-wad of ESO, ESO-ammonium hydroxide and ESO-ammonium citrate dedusting agent relative to a 40% LOI glass-wad of commercial dedusting oil.

### DETAILED DESCRIPTION OF THE INVENTION

### Introduction

Binder compositions for fiberglass are described that comprise a polycarboxylic acid such as polyacrylic acid and a crosslinking agent. The crosslinking agent comprises a polyhydroxy component formed from a reaction of an epoxidized plant oil with an amine, wherein the molar ratio of the amine to the epoxidized plant oil at the beginning of said reaction is greater than 0.5:1, e.g., greater than 0.75:1, greater than 1:1, greater than 2:1, or greater than 3:1. In terms of ranges, the molar ratio of the amine to the epoxidized plant oil at the beginning of said reaction may range from 1:1 to 3.6:1, e.g., from 1.5 to 3.0, or from 1.7 to 2. In another embodiment, binder compositions for fiberglass are described that comprise a polycarboxylic acid such as polyacrylic acid and a crosslinking agent, where the crosslinking agent comprises a polyhydroxy component formed from a reaction of an epoxidized plant oil with a phenolic compound and an amine.

In some embodiments, the polyhydroxy component may be used as a dedusting agent rather than as a crosslinking agent. In other embodiments, the polydroxy component is used both as a dedusting agent and as a crosslinking agent. Also disclosed are fiber-containing composites containing said binder compositions and methods of making such binder compositions and such fiber-containing composites. The embodiments disclosed herein advantageously provide improved thermal stability while controlling dust formation during the manufacture of fiber-containing composites. They also provide increased exotherm onset temperatures relative to conventional binder compositions, while maintaining and at times increasing desirable mechanical characteristics such as improved hydrolytic stability.

As used herein, the term “crosslinking agent” refers to a compound having the ability to form a covalent bond or a short sequence of bonds that link one polymer chain to another polymer chain upon curing, e.g., to link two polyacrylic acid polymers to one another. The term “dedusting agent” refers to a compound that is typically not crosslinked with a polymer, instead providing a surface coating to glass fibers for reducing dust formation during manufacture and handling of fiber-containing composites.

Polyhydroxy Component

The polyhydroxy components employed in the binders of the present embodiments may vary widely. In one embodiment, the polyhydroxy component is formed from a reaction of an epoxidized plant oil with an amine. In another embodiment, the polyhydroxy component is formed from a reaction of an epoxidized plant oil with a phenolic compound and an amine. In another embodiment, the polyhydroxy component is formed from a reaction of an epoxidized plant oil with an ammonium salt of an organic or inorganic acid such as citric acid, oxalic acid, sulfamic acid, sulfuric acid, phosphoric acid, sulfonic acids, phosphonic acids. The present polyhydroxy components are not limited, however, to polyhydroxy components formed exclusively from these reactants. That is, additional reactants for example dicyandiamide, melamine, urea, methylol derivatives of dicyandiamide, melamine & urea, dihydroxyethylene urea, among others, may be employed as well without departing from the scope of the present embodiments, so long as the polyhydroxy component is formed at least from the specifically claimed reactants.

Epoxidized plant oils typically are formed through the epoxidation of one or more long chain triglycerides, e.g., esters derived from glycerol and three fatty acids. In some embodiments, the epoxidized plant oil is selected from the group consisting of epoxidized soybean oil, epoxidized linseed oil, epoxidized safflower oil, epoxidized sunflower oil, epoxidized castor oil, and epoxidized tall oil fatty acid. As will be appreciated by those skilled in the art, many of these plant oils, and thus many of the corresponding epoxidized plant oils, comprise a blend of many different compounds rather than one specific compound.

The fatty acids used to form the triglycerides may comprise one or more short-chain fatty acids (SCFA), e.g., fatty acids with aliphatic tails of 5 or fewer carbons (e.g. butyric acid), medium-chain fatty acids (MCFA) acids, e.g., fatty acids with aliphatic tails of 6 to 12 carbons, long-chain fatty acids (LCFA), e.g., fatty acids with aliphatic tails of 13 to 21 carbons, or very long chain fatty acids (VLCFA), e.g., fatty acids with aliphatic tails of 22 or more carbons. In terms of ranges, the fatty acids employed in forming the triglycerides optionally have an average chain length from 18 to 26, e.g., from 16 to 24, or from 14 to 22. Thus, the corresponding triglycerides used in forming the epoxidized plant oils may similarly comprise carbon chains having any of these average chain lengths.

The epoxidation reaction used in making the epoxidized plant oils typically involves epoxidizing double bonds on the plant oils. As a result, the plant oils employed in the present embodiments preferably are formed from at least partially unsaturated fatty acids, e.g., fatty acids comprising at least one double bond, e.g., from 1 to 5 double bonds, from 1 to 4 double bonds, or from 1 to 3 double bonds. Of course, it is also contemplated that some of the fatty acids may be fully saturated, so long as others of the fatty acids used in forming the plant oils are at least partially unsaturated.

Polyunsaturated plant oils may be used as precursors for forming epoxidized plant oils because they have high numbers of carbon double bonds available for the epoxidation reaction. Epoxide groups are generally more reactive than double bonds making epoxidized plant oils well-suited for forming the polyhydroxy compounds of the present disclosure. Peroxides or peracids may be used in the epoxidation reaction to form the epoxidized plant oils according to non-limiting general reaction (1) below.

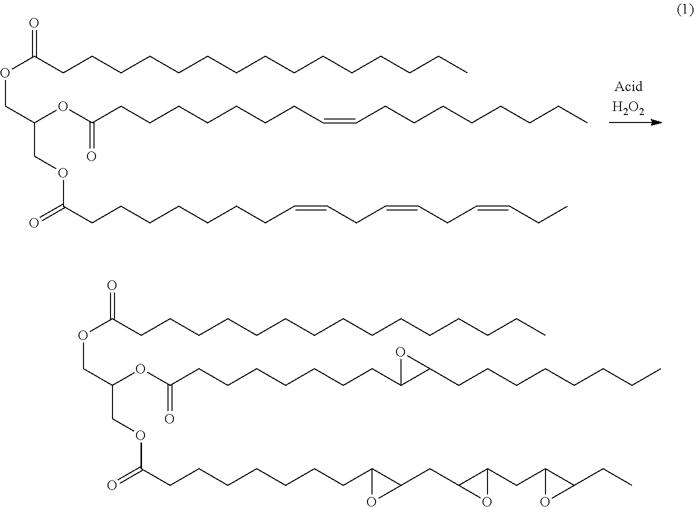 [SMILES: CC/C=C\C/C=C\C/C=C\CCCCCCCC(=O)OCC(COC(=O)CCCCCCCCCCCCCCC)OC(=O)CCCCCCC/C=C\CCCCCCCC ; CCCCCCCCCCCCCCCC(=O)OCC(COC(=O)CCCCCCCC1OC1CC1OC1CC1OC1CC)OC(=O)CCCCCCCC1OC1CCCCCCCC]

The amine used in forming the polyhydroxy components of the present disclosure optionally comprises an alkanol amine, an alkyl amine, or an alkylalkanol amine. Thus, in some aspects, the amine comprises a monoalkanol amine, a dialkanol amine, a trialkanol amine, a monoalkyl amine, a dialkyl amine, a trialkyl amine, a monoalkyldialkanol amine, a dialkylmonoalkanol amine, ammonia, or any combination thereof. In some aspects, the amine comprises a blend of one, two, three, or more amines. In terms of species, the amine optionally comprises monoethanolamine (MEA), triethanolamine (TEA), diethanolamine (DEA), butylamine, ethylenediamine, 2-dimethylaminoethanol (DMAE), 2-(diethylamino)ethanol (DEEA), 2-(dibutylamino)ethanol (DBEA), 2-[2-(diethylamino)ethoxy]ethanol (DEAE-EO), 6-methylamino-1-hexanol (DMAH), diisopropylamine (DIPA), 3-dimethylamino-1-propanol (3DMA1P), 3-diethylamino-1-propanol (3DEA1P), N-methyldiethanolamine (MDEA), N-t-butyldiethanolamine (t-BDEA), hexamethylenediamine, or a mixture thereof. Although mixtures of amines are contemplated, the amine preferably comprises at least 80 mol % of any one of these species, e.g., at least 90 mol %, at least 95 mol % or at least 99 mol % of any one of these species. Other amines may be employed as well.

As mentioned above, in some embodiments, the polyhydroxy component is formed from a reaction of an epoxidized plant oil with a phenolic compound in addition to the amine. Without being bound by theory, it is contemplated that the optional phenolic compounds may react with an amine to form a phenolate ion capable of reacting with an epoxy forming beta-hydroxy phenyl ethers. In this embodiment, the phenolic compound may be selected from any phenolic compound. Examples of phenolic compounds suitable for this embodiment include, for example, monophenols, such as phenol, cresol, t-butyl phenol, nonyl phenol, and methylol phenol. In some aspects, the phenolic compound is selected from the group of diphenols such as catechol, resorcinol, hydroquinone. In some aspects, the phenolic compound comprises a bisphenol, such as bisphenol A, bisphenol F, bisphenol S or a polyphenolic. Thus, the phenolic compound optionally comprises phenol, cresol, t-butyl phenol, nonyl phenol, methylol phenol, catechol, resorcinol, hydroquinone, bisphenol A, bisphenol F, bisphenol S, or a polyphenolic. The phenolic compound optionally comprises a mixture of phenolic compounds.

When employed in forming the polyhydroxy components of the present disclosure, the phenolic compounds optionally may be included at a phenolic compound to epoxidized plant oil molar ratio at the start of the reaction from 0.5:1 to 1:1, e.g., from 0.75:1 to 1:1.

The reaction of the epoxidized plant oil and the amine and optional phenolic compound to form the polyhydroxy compound can involve a variety of mechanisms depending on, for example, the nature of the amine compound and its functional groups (e.g., alkyl vs. alkanol), stoichiometry considerations, and reaction conditions. Without being bound by theory, in one non-limiting aspect, however, the amine group and/or the alcohol group on an amine compound and/or optional phenolic compound can act as a nucleophile inserting at an epoxy carbon to break an epoxy bond and form a carbon-nitrogen bond and/or an ether linkage and a hydroxyl group at an adjacent carbon, as shown in reactions (2) and (3), below (isomers omitted). Acids or bases optionally may be used to catalyze the reaction. Of course, other reactions between these compounds are also possible.

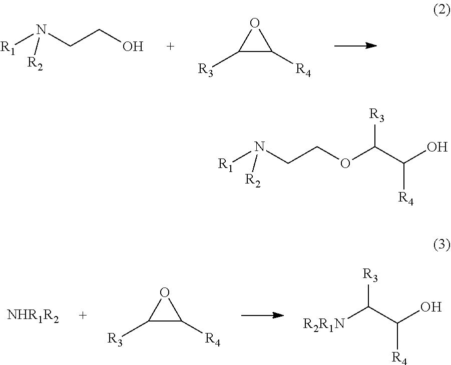

In a repeated manner, reactions such as these can break the epoxy bonds and insert hydroxyl groups on the long chain groups of the molecules thereby forming hydrophobic molecules of increased sized and hydroxyl content. The resulting polyhydroxy compounds are well-suited as crosslinking agents and/or as dedusting agents in binder compositions according to the present disclosure.

In one aspect, the epoxidized plant oil comprises epoxidized soybean oil, and the amine comprises diethanolamine. In this aspect, the diethanolamine to the epoxidized soybean oil molar ratio optionally is greater than 0.5:1, optionally from 1:1 to 4.3:1, or from 2.1:1 to 2.8:1 at the start of the reaction.

The reaction conditions for the epoxy ring-opening reaction may vary widely. In some aspects, for example, the epoxidized plant oil and the amine may be reacted in a batch process, semi-batch process, or in a continuous process. The reaction preferably occurs at elevated temperature and optionally emulsified in the presence of water with or without the aid of emulsifying agents. The reaction temperature optionally ranges from 80 to 140° C., e.g., from 90 to 130° C., or from 100 to 120° C. The reaction is preferably allowed to run fora residence time of from 1 to 10 hours, e.g., from 6 to 8 hours, preferably under continuous agitation.

The reaction may or may not occur in the presence of a catalyst, optionally a Lewis base catalyst. Examples of catalysts that may be used in forming the polyhydroxy compounds of the present disclosure include diazabicyclo octane (DABCO), tin chloride (SnCl₂), and triphenyl phosphene (TPP). In some aspects, the optional catalyst comprises a tertiary amine such as DABCO or TPP. In another aspect, the catalyst comprises an alkali metal catalyst, such as sodium hydroxide or potassium hydroxide. Thus, the reaction optionally occurs in the presence of 1,4-diazabicyclo[2.2.2]octane (DABCO), triphenylphosphine (TPP), sodium hydroxide, potassium hydroxide, or tin (II) chloride.

If used, the catalyst optionally may be used at concentrations of from 0.1 to 5 wt. %, e.g., from 0.75 to 2 wt. %, or from 0.5 to 1.5 wt. %, optionally at about 1 wt. %. The reaction chemistry is such that the conversion of reactants is particularly high, especially when catalyst is employed. In some aspects, for example, less than 3 wt. %, e.g., less than 1.5 wt. %, or less than 0.5 wt. %, of the amine remains unreacted upon completion of the reaction to form the polyhydroxy component. Similarly, for embodiments employing phenolic compounds in the formation of the polyhydroxy component, for example, less than 3 wt. %, e.g., less than 1.5 wt. %, less than 1 wt. %, less than 0.75 wt. % or less than 0.5 wt. % of the phenolic compound remains unreacted upon completion of the reaction to form the polyhydroxy component.

In some specific optional embodiments, the amine comprises diethanolamine (DEA), and the molar ratio of the diethanolamine to the epoxidized soybean oil at the beginning of the reaction is greater than 0.5:1, optionally from 1.4 to 4.3, or from 2.1 to 2.8. In another embodiment, the amine comprises triethanolamine (TEA), and the molar ratio of the triethanolamine to the epoxidized soybean oil at the beginning of the reaction is greater than 0.5:1, optionally from 1.4 to 4.3, or from 2.1 to 2.8.

The number of hydroxyl groups in the polyhydroxy component depends primarily on the reaction chemistry and stoichiometry of the reactants used to form the polyhydroxy component. These factors can be varied, for example, depending on the desired usage of the polyhydroxyl component in the binder, e.g., as a crosslinking agent and/or as a dedusting agent, as well as the number of carboxylic acid groups in the polymer to be cured, e.g., polyacrylic acid. In some non-limiting embodiments, the molar ratio of hydroxyl groups in said polyhydroxy component to carboxylic acid groups in said polyacrylic acid ranges from 0.25:1 to 2:1, e.g., from 0.5:1 to 1.5:1.

Binder Compositions

The polyhydroxy components of the present disclosure optionally may be used as crosslinking agents in a binder composition for crosslinking a polymer, especially a polycarboxylic acid such as polyacrylic acid polymers, upon curing to bind fibrous material together. When used as a crosslinking agent, the polyhydroxy compounds are reacted with the polycarboxylic acid, e.g., polyacrylic acid, optionally in the presence of a catalyst and any optional secondary components, thereby curing the composition to bind the fibrous material together. Thus, the binder compositions comprise a polycarboxylic acid, e.g., polyacrylic acid, a crosslinking agent, and optionally a curing catalyst, where the crosslinking agent comprises the polyhydroxy component of the present disclosure (fully described above) and optionally one or more secondary components (secondary crosslinkers).

Additionally disclosed are processes for making such binder compositions. In one embodiment, the method of forming a binder composition for fiberglass comprises reacting an epoxidized plant oil with an amine optionally in the presence of a catalyst to form a polyhydroxy crosslinking agent, wherein the molar ratio of the amine to the epoxidized plant oil at the beginning of said reacting step is greater than 1:1, and mixing said polyhydroxy crosslinking agent with polyacrylic acid to form the binder composition. In another embodiment, the method of forming a binder composition for fiberglass comprises reacting an epoxidized plant oil with a phenolic compound and an amine optionally in the presence of a catalyst to form a polyhydroxy crosslinking agent; and mixing the polyhydroxy crosslinking agent with polyacrylic acid to form the binder composition.

Thus, in one embodiment, the binder composition comprises a polymer, e.g., polyacrylic acid, and a crosslinking agent, wherein the crosslinking agent comprises a polyhydroxy component formed from a reaction of an epoxidized plant oil with an amine, wherein the molar ratio of the amine to the epoxidized plant oil at the beginning of the said reaction is greater than 1:1. In another embodiment, the polyhydroxy component is formed from a reaction of an epoxidized plant oil with a phenolic compound and an amine, and the molar ratio of the amine to the epoxidized plant oil at the beginning of the said reaction optionally is greater than 1:1.

The polymer to be crosslinked upon curing preferably comprises a polycarboxylic acid. Although the subject specification primarily refers to acrylic acid polymers, the polycarboxylic acids crosslinked according to the embodiments of the disclosure may include any polycarboxy monomer, or any polycarboxy homopolymer, and/or copolymer prepared from ethylenically unsaturated carboxylic acids including, but not limited to, acrylic acid, methacrylic acid, butenedioic acid (i.e., maleic acid and/or fumaric acid), methyl maleic acid, itaconic acid, and crotonic acid, among other carboxylic acids. The polycarboxy polymer may also be prepared from ethylenically unsaturated acid anhydrides including, but not limited to, maleic anhydride, acrylic anhydride, methacrylic anhydride, itaconic anhydride, among other acid anhydrides.

Thus, in some aspects the polycarboxylic acid comprises a monomeric polycarboxylic acid selected, for example, from the group consisting of citric acid, itaconic acid, maleic acid, adipic acid, oxalic acid, trimellitic acid, and butanetetracarboxylic acid. In other aspects, the polycarboxylic acid comprises a homopolymer or copolymer formed at least in part from acrylic acid, methacrylic acid, butenedioic acid, methyl maleic acid, itaconic acid, crotonic acid, maleic anhydride, acrylic anhydride, methacrylic anhydride, itaconic anhydride, maleic acid, or fumaric acid. Additionally, the polycarboxy polymer of the present invention may be a copolymer of one or more of the aforementioned unsaturated carboxylic acids or acid anhydrides and one or more vinyl compounds including, but not limited to, styrenes, acrylates, methacrylates, acrylonitriles, methacrylonitriles, among other compounds. More specific examples of the polycarboxy polymer may include copolymers of styrene and maleic anhydride, and its derivatives including its reaction products with ammonia and/or amines. For example, the polycarboxy polymer may be the polyamic acid formed by the reaction between the copolymer of styrene and maleic anhydride and ammonia.

The molecular weight of the polymer may vary depending on the specific polymer. For polyacrylic acid polymers, the molecular weight (Mw) optionally ranges from 1000-100,000 amu, e.g., from 1000 to 50,000 amu, from 1000 to 10,000 amu, from 2000 to 10,000 amu, or from 3000 to 5000.

The polymer compound may be a solution polymer that helps make a rigid thermoplastic binder when cured. In contrast, when the polymer compound is an emulsion polymer, the final binder compositions are usually less rigid (i.e., more flexible) at room temperature.

In some aspects, the polymer, e.g., acrylic acid polymer, may be crosslinked with the polyhydroxy component and a secondary component, i.e., secondary crosslinking agent. In this aspect, the secondary component optionally may be selected from the group consisting of sorbitol, triethanolamine, diethanolamine, monoethanolamine, polyvinyl alcohol, glycerol, propylene glycol, neopentyl glycol, trimethylol propane, pentaerythritol, polyester polyol, and acrylic polyols. The secondary component may include compounds containing at least two reactive functional groups including, but not limited to, hydroxyl, carboxyl, amine, aldehydes, isocyanate, and epoxide, among other functional groups. Examples of suitable secondary components may include polyols, alkanol amines, polycarboxylic acids, polyamines, and other types of compounds with at least two functional groups that can undergo crosslinking with other binder ingredients, such as the polymer compound.

Specific examples of polyols suitable as an optional secondary component include sorbitol, glycerol, ethylene glycol, propylene glycol, diethylene glycol, and triethylene glycol, maltodextrin, starch, and polyvinyl alcohol among other polyols. Specific examples of alkanol amines may include ethanolamine, diethanolamine, monoethanolamine, and triethanolamine, among other alkanol amines. Specific examples of polycarboxylic acids may include malonic acid, succinic acid, glutaric acid, citric acid, propane-1,2,3-tricarboxylic acid, butane-1,2,3,4-tetracarboxylic acid, among other polycarboxylic acids. Specific examples of polyamines may include ethylene diamine, hexane diamine, and triethylene diamine, among other polyamines. Specific examples of epoxies may include bisphenol-A based epoxies, aliphatic epoxies, epoxidized oils, among other epoxy compounds.

The crosslinking agent may comprise the polyhydroxy component in an amount from 5 to 100 wt. %, based on total weight of the crosslinking agent. Thus, in various optional embodiments, the crosslinking agent may comprise: (i) the polyhydroxy component in an amount from 5 to 100 wt. %, e.g., from 5 to 25 wt. %, from 25 to 75 wt. %, or from 75 to 95 wt. %, and (ii) a secondary component in an amount from 0 to 95 wt. %, e.g., from 75 to 95 wt. %, from 25 to 75 wt. %, or from 5 to 25 wt. %, based on the total weight of crosslinking agent. When employed, the secondary component may be provided at a polyhydroxy component to secondary component mass ratio at the beginning of the crosslinking reaction (curing step) from 99:1 to 1:1, e.g., from 90:1 to 10:1, or from 1:1 to 99:1. In some aspects, the crosslinking agent is free of, i.e., does not contain, any detectable secondary component. When included, the secondary component optionally is a polyol selected from the group consisting of sorbitol, triethanolamine, diethanolamine, polyvinyl alcohol, glycerol, propylene glycol, neopentyl glycol, trimethylol propane, pentaerythritol, polyester polyol, and acrylic polyols. In this aspect, the mass ratio of polyhydroxy component to secondary component optionally is in the range of from 11:89 to 99:1, e.g., from 15:85 to 90:10, or from 30:70 to 70:30. When included, the amount of the secondary component provided relative to the polycarboxylic acid, e.g., polyacrylic acid, at the start of the crosslinking reaction optionally ranges from a 0.1:1 to 2.5:1 w/w, e.g., from 2:1 to 2.5:1, from 0.75:1 to 1.25:1, or from 0.05:1 to 0.2:1 w/w of the secondary component to the polycarboxylic acid. Regardless of whether a secondary component is employed, the total weight ratio of crosslinking compounds (e.g., polyhydroxy compound plus optional secondary component(s)) to polymer (e.g., polyacrylic acid) at the start of the crosslinking reaction optionally ranges from 0.5:1 to 2:1, e.g., from 1:1 to 2:1, or from 1.5:1 to 1:1 (w/w).

The binder compositions may also optionally include a cure catalyst. Examples of cure catalysts may include phosphorous-containing compounds such as phosphorous oxyacids and their salts. For example, the cure catalyst may be an alkali metal hypophosphite salt like sodium hypophosphite (SHP). The cure catalyst may be added to expedite curing of the binder composition.

The binder compositions may also optionally include extenders. Examples of extenders may include starch, lignin, rosin, among other extenders.

The binder compositions may also optionally contain pH adjustment agents. For example, the present binder compositions and solution may include one or more acids or bases that maintain the pH between 2-8.

The present binder compositions may also exclude materials that have deleterious effects on the cured binder. For example, the binder compositions may have decreased levels of reducing sugars (or no reducing sugars at all) to reduce or eliminate Maillard browning that results from the reaction of these sugars at elevated temperatures. Some binder compositions made from renewable materials can contain substantial levels of reducing sugars and other carbohydrates that produce a brown or black color in the cured binder. As a result, products made with these binder compositions are difficult or impossible to dye.

Examples of the present binder compositions include compositions where the concentration of reducing sugars is decreased to a point where discoloration effects from Maillard browning are negligible. The fully cured binders may have a white or off-white appearance that allows them to be easily dyed during or after the curing process.

The inventive polyhydroxy component is not restricted to polycarboxylic acid based binders such as polyacrylic acid based binders. Instead, the inventive polyols can replace traditional dedusting oils used in traditional fiberglass binders such as formaldehyde-based binders, e.g., phenol-formaldehyde (PF), urea-formaldehyde (UF), melamine-formaldehyde (MF) binders, and combinations thereof, and formaldehyde-free binders such as polyesters, melanoidin-based binders, epoxy resin, acrylic resin, polyurethanes, and combinations thereof.

Thus, in one aspect, the inventive polyhydroxy component may also be employed as a crosslinking agent or a dedusting agent for formaldehyde-based binders and formaldehyde-free binders. For example, in one aspect a binder composition for fiberglass is disclosed, comprising a formaldehyde-based binder and a crosslinking agent, wherein the crosslinking agent comprises a polyhydroxy component derived from epoxidized plant oil, wherein the polyhydroxy component is formed from a reaction of an epoxidized plant oil with an amine and optionally with a phenolic compound. The formaldehyde-based binder optionally may be selected from the group consisting of a phenol-formaldehyde based binder, a urea-formaldehyde based binder, a melamine-formaldehyde based binder, and any combination thereof.

In another aspect, a binder composition for fiberglass is disclosed, comprising a formaldehyde-free binder and a crosslinking agent, wherein the crosslinking agent comprises a polyhydroxy component derived from epoxidized plant oil, wherein the polyhydroxy component is formed from a reaction of an epoxidized plant oil with an amine and optionally with a phenolic compound. In this aspect, the formaldehyde-free binder optionally may be selected from the group consisting of a polyesters, melanoidin-based resin, epoxy resin, acrylic resin, polyurethanes, and any combination thereof.

Methods of Making Fiber Composites

The present binder compositions may be used in methods of making fiber products. The methods may include applying a solution of the binder composition to fibers and curing the binder composition on the fibers to form the fiber product. The binder solution may be spray coated, spin coated, curtain coated, knife coated, or dip coated onto fibers. Once the liquid binder composition is applied, the binder and substrate may be heated to cure the binder composition and form a composite of cured binder and fibers that make up the fiber product.

The binder solution may be formed to have a viscosity in range that permits the efficient application of the solution to the fibers. For example, the viscosity may be about 10 centipoises to about 1500 centipoises when the binder solution is at room temperature.

If the viscosity of the liquid binder applied to the substrate is too high, it may slow down the application process both at the release point for the binder as well as the rate of mixing and coverage of the binder on the substrate.

After application of the liquid binder composition on the substrate, the amalgam of liquid binder and substrate undergoes curing. In the curing process the polymer compound, the polyhydroxy component, and optional secondary component (i.e., secondary crosslinking agent) may form covalently crosslinked bonds among each other to convert the amalgam into a thermoset composite. When a thermal curing process is used, the amalgam may be subjected to an elevated temperature (e.g., up to 300° C.) to facilitate crosslinking in the binder. The peak curing temperature may depend on the specific formulation of the binder composition, the substrate, and whether a cure catalyst is used. The cured material typically includes about 0.5 wt % to about 50 wt % thermoset binder composition (e.g., about 1 wt. % to about 10 wt. %) with the substrate representing most of the remaining weight.

The binder composition may be a stable one-part composition that can be recycled during the application to the fibers and/or between applications on fibers. Thus, an unused portion of the binder solution that, for example, passes through the fibers may be captured and sent back to the supply of binder solution applied to the fibers. In some embodiments, the unused portion of the binder solution may be purified or otherwise treated before returning to the supply.

The reuse of the binder solution may not only reduce the amount of solution used, it may also reduce the amount of waste materials that must be treated and discarded. However, recycling unused binder solution requires that the solution remain stable for two or more application cycles. In many instances, two-part binder compositions that mix separated and highly reactive components immediately before their application will cure too rapidly to be recycled. One-part binder compositions may also be unsuitable if they do not have a sufficient pot life to remain relatively unreacted prior to use and during recycling. The present binder compositions include one-part binder compositions that are stable enough to be appropriate for binder solution recycling.

Fiber-Containing Composites

The present binder compositions may be added to fibers to produce fiber-containing composite products. The fibers may include organic fibers and/or inorganic fibers. Examples of the fibers may include polymer fibers and/or glass fibers, among other types of fibers. The fibers may be arranged as an insulation batt, woven mat, non-woven mat, or spunbond product, among other types of fiber substrate. Thus, in one embodiment the fiber-containing composite comprises (a) woven or non-woven fibers; and (b) a cured binder that holds the fibers together, wherein the binder comprises a polymer, e.g., polyacrylic acid, crosslinked by a crosslinking agent, wherein the crosslinking agent comprises a polyhydroxy component formed from a reaction of an epoxidized plant oil with an amine, and wherein the molar ratio of the amine to the epoxidized plant oil at the beginning of said reaction is greater than 1:1. In another embodiment, the fiber-containing composite comprises (a) woven or non-woven fibers; and (b) a cured binder that holds the fibers together, wherein the binder comprises a polymer, e.g., polyacrylic acid, crosslinked by a crosslinking agent, wherein the crosslinking agent comprises a polyhydroxy component formed from a reaction of an epoxidized plant oil with a phenolic compound and an amine.

In some aspects, the binder composition may be formulated with an excess of the polyhydroxy component of the present disclosures, such that upon curing, some of the polyhydroxy component does not crosslink with the polymer, e.g., polyacrylic acid, resulting in a mobile hydrophobic polyhydroxy component that optionally is free to migrate to the surface of the fiber-containing composite, and which can act as a dedusting agent rather than as a crosslinking agent. It is also contemplated that some of the polyhydroxy component may act as a crosslinking agent while excess polyhydroxy component may serve as a dedusting agent. In another aspect, a binder composition (optionally containing polyhydroxy component or a different crosslinking agent) is applied to a fiber substrate and subsequently cured, followed by a separate application of the above-described polyhydroxy component, which acts as a dedusting agent.

Thus, in one embodiment, the disclosure relates to a cured binder composition for fiberglass, comprising: (i) a crosslinked polyacrylic acid, and (ii) a dedusting agent, wherein the dedusting agent comprises a polyhydroxy component formed from a reaction of an epoxidized plant oil with an amine, wherein the molar ratio of the amine to the epoxidized plant oil at the beginning of said reaction is greater than 1:1. In another embodiment, the disclosure relates to a cured binder composition for fiberglass, comprising: (i) a crosslinked polyacrylic acid, and (ii) a dedusting agent, wherein the dedusting agent comprises a polyhydroxy component formed from a reaction of an epoxidized plant oil with a phenolic compound and an amine.

The subject binders are particularly well-suited for forming fiber-containing composites that exhibit a high degree of thermal resistance. For example, in some embodiments, the resulting compositions with 10% by mass of polyhydroxy component, after curing may have an onset of exotherm of greater than 250° C., e.g., greater than 280° C., greater than 290° C. or greater than 300° C. The composites also preferably exhibit hydrolytic stability, having a humid aged tensile strength according to dogbone tensile testing, as defined herein, of greater than 1.5 MPa, e.g., greater than 2.0 Mpa.

Dogbone Preparation and Testing Protocol

As used herein, the “dogbone” test refers to testing on a dogbone-shaped sample that is made by combining the binder compositions of the present disclosure with borosilicate glass beads having an average diameter of 1 mm. The bead-binder composition amalgam is poured into dogbone molds roughly 25 mm wide and 6 mm thick and allowed to cure. The dogbone shaped samples should be cured in an oven at 210° C. for 20 minutes. Each dogbone sample should include about 2.5 wt. % (L01) of the cured binder. The samples are further divided into unaged samples that are tested directly after being released from the molds and humid-aged samples that are placed in a humidifying oven for 24 hours at 90° F. (32.2° C.) and 90% relative humidity. Each dogbone sample should be tested in the same Instron tensile strength testing apparatus to measure its tensile strength (Harry W. Dietert Col.— Tensile Core Grip Assembly Part No. 610-7CA).

The present binder compositions may be used in fiber products to make insulation and fiber-reinforced composites, among other products. The products may include fibers (e.g., organic and/or inorganic fibers) contained in a cured thermoset binder prepared from a one-part binder solution of a polymer compound, the polyhydroxy component and an optional secondary component that is crosslinkable with the polymer compound. The fibers may include glass fibers, carbon fibers, and organic polymer fibers, among other types of fibers. For example, the combination of the binder composition and glass fibers may be used to make fiberglass insulation products. Alternatively, when the fiberglass is a microglass-based substrate, the binder may be applied and cured to form printed circuit boards, battery separators, filter stock, and reinforcement scrim, among other articles.

The binder compositions may be formulated to impart a particular color to the fiber product when cured. For example, the concentration of reducing sugars in the binder compositions may be lowered to give the fiber product a white or off-white color when cured. Alternatively, a dye may be added to binder composition before, during, or after the curing stage to impart a particular color to the final fiber product (e.g., red, pink, orange, yellow, green, blue, indigo, violet, among many other colors).

### EXAMPLES

The following Examples are presented to provide specific representative embodiments of the present invention. The invention is not limited to the specific details as set forth in these Examples.

### Example 1: DEA-ESO (1:1) Hydrophobic Polyol Manufacture without Catalyst

One mole (105 g) of diethanolamine (DEA) was added to one mole (950 g) of epoxidized soybean oil (ESO) having 4.5 epoxy equivalents. The resulting mixture was heated to 130° C. for 1 hour. A clear, uniform liquid product was formed. The product was tested for percent unreacted monomers.

Thermal Stability

The thus manufactured hydrophobic polyol (which may be used as a crosslinking agent or a dedusting agent) was evaluated for its thermal stability. The exotherm resistance of two commercial polycarboxylic acid/polyol binders with 10% of the inventive hydrophobic polyol was also evaluated. The exotherm was evaluated by forming binder wads with 40% LOI. The glass-wad was sandwiched in R19 batts, compressed to a density of 2.8 pounds per cubic foot (44.9 kg/m 3), and placed in an oven maintained at 475° F. (246° C.). Exotherm data was collected by use of a thermocouple to measure the temperature at the center of the glass-wads as a function of time.

Onset of Exotherm

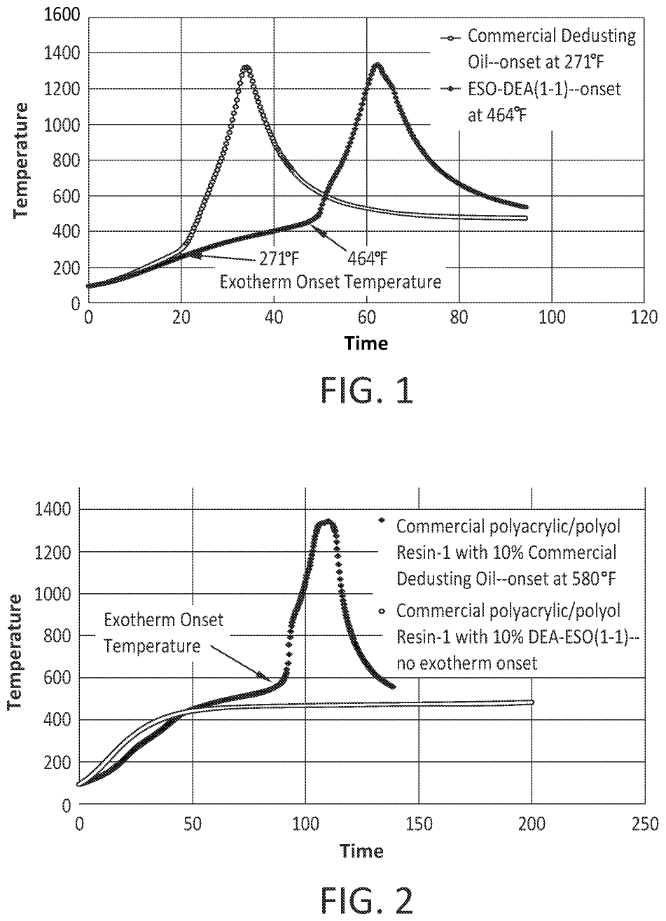

The resulting exotherm of Example 1 is shown in FIG. 1 for an DEA-ESO mole ratio of 1:1 against a commercial dedusting oil utilized in the manufacturing of insulation products. As shown in FIG. 1, onset of exotherm (which is indicative of thermal stability) for the embodiment having DEA-ESO-based dedusting agent was significantly greater (193° F. (107° C.) greater) than that for the comparative commercial dedusting oil, indicating.

Thermal Stability

The effect of addition of 10 wt. % of the DEA-ESO (1:1) hydrophobic polyol of Example 1 to commercial polyacrylic binder-1 was evaluated by testing its exotherm and comparing it to the exotherm of the commercial polyacrylic binder-1 containing commercial dedusting oil. The results, shown in FIG. 2, surprisingly and unexpectedly demonstrate that no exotherm was observed with the addition of hydrophobic polyol according to the present disclosure (Example 1). This data supports that binder thermal stability was significantly improved according to the hydrophobic polyols of the present disclosure.

Mechanical Performance

Mechanical performance also was evaluated by testing Recovery & Droop of fiberglass R19 insulation with commercial dedusting oil and comparing it to the Recovery & Droop of R19 insulation containing polyol DEA-ESO (3:1) according to the present disclosure without commercial dedusting oil. The results are compared in Table 1 and show that replacing commercial dedusting oil with DEA-ESO polyol according to the present disclosure improved the recovery & droop performance of R19 insulation both as received and after exposure to high temperature and relative humidity (RH) conditions (90° F. and 90% RH) in sag-room.

TABLE 1
Mechanical Performance

| | As-received | | Sag-room | As-received | Sag-room |
|---|---|---|---|---|---|
| | Recovery | | Recovery | Droop | Droop |
| | (in (cm)) | | (in (cm)) | (in (cm)) | (in (cm)) |
| Commercial | 5 | (12.7) | 4.8 (12.2) | 6.1 (15.5) | 6.6 (16.8) |
| polyacrylic/ | | | | | |
| polyol resin | | | | | |
| 1 with commercial | | | | | |
| dedusting oil | | | | | |
| Commercial | 5.5 | (14.0) | 4.9 (12.5) | 4.3 (10.9) | 4.8 (12.2) |
| polyacrylic/ | | | | | |
| polyol resin | | | | | |
| 1 with | | | | | |
| DEA-ESO (3:1) | | | | | |
| Commercial | 4.8 | (12.2) | 4.8 (12.2) | 5.5 (14.0) | 5.5 (14.0) |
| polyacrylic/ | | | | | |
| polyol resin | | | | | |
| 2 with commercial | | | | | |
| dedusting oil | | | | | |
| Commercial | 5.1 | (13.0) | 4.8 (12.2) | 4.7 (11.9) | 4.8 (12.2) |
| polyacrylic/ | | | | | |
| polyol resin | | | | | |
| 2 with | | | | | |
| DEA-ESO (3:1) | | | | | |

Dust Data

Total dust data for a R-19 insulation product containing 10 wt. % commercial dedusting oil vs 10% ESO vs 10% DEA-ESO(1-1) polyol is shown in Table 2 below. The dust results were extremely similar, confirming the ability to replace commercial dedusting oil with either ESO or the hydrophobic polyols described herein.

TABLE 2
Total Dust Data for R19 Insulation with 10% Commercial
Dedusting Oil vs 10% Inventive Polyols

| Dedusting Agent | Total Dust (g/10,000 ft² (g/929 m²)) |
|---|---|
| Commercial dedusting oil | 24.92 |
| ESO | 28.57 |
| DEA-ESO (1:1) | 25.56 |

### Example 2: DEA-ESO (3:1) Polyol Manufacture with Catalyst

The effect of catalyst on the level of unreacted DEA in the DEA-ESO (3:1) systems was also assessed. 3 moles (315 g) of DEA and 1 mole (950 g) of ESO in the presence of 1 wt. % catalyst including diazabicyclo-octane (DABCO) and tin chloride (SnCl₂) were reacted in the same manner as described in Example 1. As shown in Table 3, the level of unreacted DEA reduced significantly when DABCO and tin chloride (SnCl₂) catalyst was employed, indicating that DABCO and SnCl₂ catalyst was effective in catalyzing the reaction of DEA-ESO (3:1) at 110° C. for 8 hours.

TABLE 3
Effects of Catalyst on DEA-ESO Reaction

| Polyol System | Wt. % Unreacted DEA |
|---|---|
| DEA-ESO (3:1) (no catalyst) | 1.92 |
| DEA-ESO (3:1) (1 wt. % DABCO) | 0.75 |
| DEA-ESO (3:1) (1 wt. % SnCl₂) | 1.08 |

### Example 3: NP-DEA-ESO (1-3-1) Polyol Manufacture

One mole of Nonyl Phenol (NP) was mixed with three moles (315 g) of DEA. To this mixture was added one mole (950 g) of ESO (having 4.5 epoxy equivalents). The resulting mixture was heated to 110° C. for 8 hours without catalyst addition. A clear uniform liquid product was formed. The formed polyhydroxy compound was characterized with 99% and 73% conversion rate for DEA and nonylphenol, respectively.

### Examples 4-9

In Examples 4-9, Example 3 was repeated using different ratios of reactants, and with and without catalyst as shown in Table 4. Similar results were achieved.

TABLE 4
Examples 4-9

| | NP-DEA-ESO Molar | |
|---|---|---|
| Example | Ratio | Catalyst |
| 4 | 2:2:1 | None |
| 5 | 1:3:1 | None |
| 6 | 1:3:1 | DABCO (1 wt. %) |
| 7 | 1:3:1 | Triphenyl Phosphene (TPP) (1 wt. %) |
| 8 | 1:3:1 | Tin Chloride (SnCl₂) (1 wt. %) |
| 9 | 4:3:1 | None |

### Example 10: TBP-DEA-ESO (1:3:1) Polyol Manufacture

One mole (150 g) of t-butyl phenol (TBP) was mixed with three moles (315 g) of DEA. To this mixture was added one mole (950 g) of ESO (having 4.5 epoxy equivalents). The resulting mixture was heated to 110° C. for 8 hours without catalyst. A uniform clear liquid product was formed having 2.33% and 1.23% remaining content of unreacted DEA and TBP, respectively.

### Example 11: NP-MEA-DEA-ESO (2:1:2:1) Polyol Manufacture

Two moles (440 g) of NP were mixed with 1 mole (61 g) of monoethanol amine (MEA), and 2 moles (210 g) DEA. To this mixture was added one mole (950 g) of ESO (having 4.5 epoxy equivalents). The resulting mixture was heated to 110° C. for 8 hours. A low melting point wax was formed.

### Example 12: NP-MEA-DEA-ESO (2:2:2:1) Polyol Manufacture

Two moles (440 g) of NP were mixed with two moles (122 g) of monoethanol amine (MEA), and 2 moles (210 g) DEA. To this mixture was added one mole (950 g) of ESO (having 4.5 epoxy equivalents). The resulting mixture was heated to 110° C. for 8 hours without catalyst. A waxy solid was formed.

Analysis of Examples 3-12

The thus manufactured dedusting agents (which additionally or alternatively may be used as crosslinking agents) were evaluated for thermal resistance as dedusting oils with two commercially available polyacrylic resin systems (Mw 1,000-50,000). The exotherm was evaluated by forming wads with 40% LOI for all samples. The glass-wad was sandwiched in R19 batts under 2.8 pounds per cubic foot (44.9 kg/m 3) and placed in an oven maintained at 475° F. (246° C.). Exotherm data was collected by measuring the temperature at the center of the glass-wads as a function of time.

Onset of Exotherm

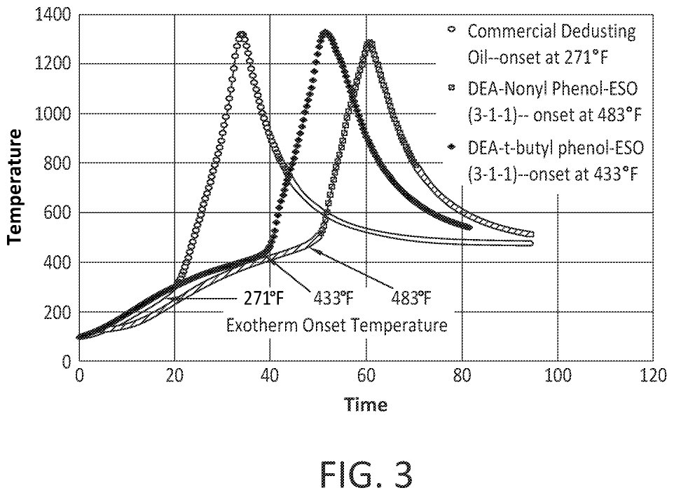

The resulting exotherms of Examples 5 and 10 are shown in FIG. 3 compared to a commercial dedusting oil utilized in the manufacturing of insulation products.

In testing for onset of exotherm, a pristine glass substrate is impregnated with desired binder composition solution to generate a binder-wad. The uncured binder wad is cured in an oven set at 210° C. to mimic standard production conditions and product LOI (Loss-On-Ignition). A thermocouple is placed inside of cured wad sample with 40% LOI. The cured binder wad is sandwiched between R19 insulation bats and subjected to a compression of 2.8 pounds-per-cubic-foot (pcf) (44.9 kg/m³). The cured binder wad under compression is then placed in an oven of 475° F. (246° C.) to obtain exotherm profile.

As shown in FIG. 3, onset of exotherm for embodiments having Phenolic-DEA-ESO-based dedusting agents surprisingly and unexpectedly was significantly greater (212° F.) for NP-DEA-ESO (1:3:1) and 162° F. greater for butyl phenol-DEA-ESO (1:3:1) than that for the comparative commercial dedusting oil. The exotherm profile obtained on dedusting agents Nonylphenol (NP)-DEA-ESO (1:3:1) and t-butylphenol (TBP)-DEA-ESO (1:3:1) showed improvement in thermal stability of phenolic-modified deducting agents.

Additionally, onset of exotherm temperature data was determined for commercial dedusting oil, unaltered epoxidized soybean oil, and DEA-ESO dedusting agents manufactured according to the present disclosure at ratios of 1:1, 2:1, 3:1, and 5:1. The exotherm onset temperatures of these compositions are provided in Table 5 below, and support that the polyols according to the present disclosure have substantially higher thermal stability than commercial dedusting oils and unaltered epoxidized plant oils.

TABLE 5
Exotherm Onset Temperature Data for
DEA-ESO at Different Molar Ratios

| Polyols | Exotherm Onset Temperature (° C.) |
|---|---|
| Commercial Dedusting Oil | 133 |
| Plain ESO | 172 |
| DEA-ESO (1:1) | 240 |
| DEA-ESO (2:1) | 226 |
| DEA-ESO (3:1) | 213 |
| DEA-ESO (5:1) | 212 |

Mechanical Performance

Mechanical performance was evaluated by testing Recovery & Droop of fiberglass R19 insulation with commercial dedusting oil and compared with Recovery & Droop of R19 insulation containing the inventive polyol NP-DEA-ESO (1:3:1) of Example 5 without commercial dedusting oil. The results are compared in Table 6, which shows that replacing commercial dedusting oil with the NP-DEA-ESO polyol according to the present disclosure improved the recovery & droop performance of R19 insulation both as received and after exposure to high temperature and relative humidity (RH) conditions (90° F. and 90% RH) in sag-room.

TABLE 6
Mechanical Performance

| | As-received | Sag-room | | As-received | Sag-room |
|---|---|---|---|---|---|
| | Recovery | Recovery | | Droop | Droop |
| | (in (cm)) | (in (cm)) | | (in (cm)) | (in (cm)) |
| Commercial | 4.8 (12.2) | 4.8 | (12.2) | 5.5 (14.0) | 5.5 (14.0) |
| polyacrylic/polyol | | | | | |
| resin- 2 with | | | | | |
| commercial | | | | | |
| dedusting oil | | | | | |
| Commercial | 5.1 (13.0) | 5 | (12.7) | 4.8 (12.2) | 5.2 (13.2) |

polyacrylic/polyol
resin-2 with NP-
DEA-ESO(1:3:1)

Effect of Catalyst on NP-DEA-ESO (1:3:1) Polyol Manufacture

The effects of catalyst on the level of unreacted DEA and unreacted NP in the NP-DEA-ESO (1:3:1) systems of Examples 5, 6, and 8 were also assessed. As shown in Table 7, the level of unreacted DEA and unreacted NP reduced significantly when DABCO and tin chloride (SnCl₂) catalyst was employed, indicating that DABCO and SnCl₂ catalyst were effective in catalyzing the reaction of NP-DEA-ESO (1:3:1) at 110° C. for 4 hours.

TABLE 7
Effects of Catalyst on DEA-ESO Reaction

| | Wt. % | Wt. % |
|---|---|---|
| | Unreacted | Unreacted |
| Polyol System | DEA | NP |
| Example 5: NP-DEA-ESO | 1.35 | 0.5 |
| (1:3:1) (no catalyst) | | |
| Example 6: NP-DEA-ESO | 1.3 | 0.15 |
| (1:3:1) (1 wt. % DABCO) | | |
| Example 8: NP-DEA-ESO | 0.9 | 9.9 |
| (1:3:1) (1 wt. % SnCl₂) | | |

### Examples 13 and 14: ESO-Ammonium Hydroxide and ESO-Ammonium Citrate Polyol Manufacture

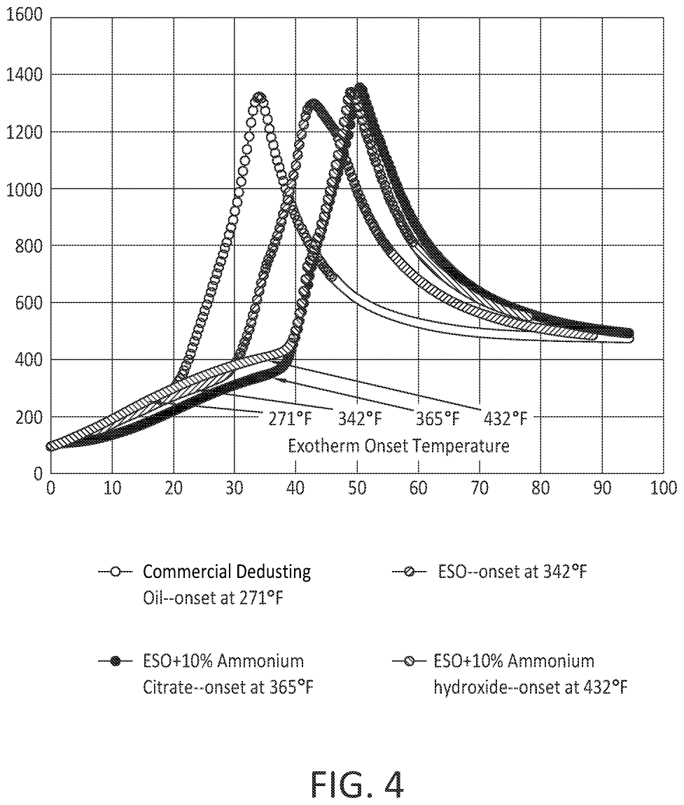

In Example 13, 1 mole ESO was agitated with 1-3 moles of aqueous ammonium hydroxide (29% concentration) at room temperature for 1-24 hrs. In the exotherm graph shown in FIG. 4, 1 mole ESO was mixed with 2 moles of ammonium hydroxide for 24 hrs. In Example 14, for ESO polyols based on ammonium citrate, ESO was agitated with a 30% aqueous ammonium citrate solution at room temperature for 24 hrs, where the dry solids mass ratio of ESO to ammonium salt was 90:10. As shown in FIG. 4, the inventive polyols including ESO, which is a precursor to polyol, has higher exotherm inflection temperature compared to commercial dedusting oil.

Where a range of values is provided, it is understood that each intervening value, to the tenth of the unit of the lower limit unless the context clearly dictates otherwise, between the upper and lower limits of that range is also specifically disclosed. Each smaller range between any stated value or intervening value in a stated range and any other stated or intervening value in that stated range is encompassed. The upper and lower limits of these smaller ranges may independently be included or excluded in the range, and each range where either, neither or both limits are included in the smaller ranges is also encompassed within the invention, subject to any specifically excluded limit in the stated range. Where the stated range includes one or both of the limits, ranges excluding either or both of those included limits are also included.

As used herein and in the appended claims, the singular forms “a”, “an”, and “the” include plural referents unless the context clearly dictates otherwise. Thus, for example, reference to “a process” includes a plurality of such processes, and so forth.

Also, the words “comprise,” “comprising,” “include,” “including,” and “includes” when used in this specification and in the following claims are intended to specify the presence of stated features, integers, components, or steps, but they do not preclude the presence or addition of one or more other features, integers, components, steps, acts, or groups.

What is claimed is:

1. A binder composition for fiberglass, comprising a polycarboxylic acid and a crosslinking agent, wherein the crosslinking agent comprises a polyhydroxy component derived from epoxidized plant oil, the polyhydroxy component formed from a reaction of an epoxidized plant oil with an amine and optionally with a phenolic compound.

2. The binder composition of claim 1, wherein the molar ratio of the amine to the epoxidized plant oil at the beginning of said reaction is greater than 0.5:1.

3. The binder composition of claim 1, wherein the amine comprises a monoalkanol amine, a dialkanol amine, a trialkanol amine, monoalkyl ethanol amine, a monoalkyl amine, a dialkyl amine, or ammonia.

4. The binder composition of claim 1, wherein the phenolic compound comprises phenol, cresol, t-butyl phenol, nonyl phenol, methylol phenol, catechol, resorcinol, hydroquinone, bisphenol A, bisphenol F, bisphenol S, or a polyphenolic.

5. The binder composition of claim 1, wherein the epoxidized plant oil comprises epoxidized soybean oil, epoxidized linseed oil, epoxidized safflower oil, epoxidized sunflower oil, epoxidized castor oil, or epoxidized tall oil fatty acid.

6. The composition of claim 1, wherein the amine comprises monoethanol amine, diethanol amine, triethanol amine, butylamine, ethylenediamine, or hexamethylenediamine.

7. The composition of claim 1, wherein the crosslinking agent comprises the polyhydroxy component and a secondary component, wherein the secondary component is selected from the group consisting of sorbitol, triethanolamine, diethanolamine, polyvinyl alcohol, glycerol, propylene glycol, neopentyl glycol, trimethylol propane, pentaerythritol, polyester polyol, and acrylic polyols.

8. The composition of claim 1, wherein the polycarboxylic acid comprises a monomeric polycarboxylic acid selected from the group consisting of citric acid, itaconic acid, maleic acid, adipic acid, oxalic acid, trimellitic acid, butanetetracarboxylic acid.

9. The composition of claim 1, wherein the polycarboxylic acid comprises a homopolymer or copolymer formed at least in part from acrylic acid, methacrylic acid, butenedioic acid, methyl maleic acid, itaconic acid, crotonic acid, maleic anhydride, acrylic anhydride, methacrylic anhydride, itaconic anhydride, maleic acid, or fumaric acid.

10. The composition of claim 1, wherein the epoxidized plant oil comprises epoxidized soybean oil, wherein the amine comprises diethanolamine, and wherein the diethanolamine to the epoxidized soybean oil molar ratio is greater than 0.5:1.

11. The composition of claim 1, wherein the reaction occurs in the presence of 1,4-diazabicyclo[2.2.2]octane (DABCO), triphenylphosphine (TPP), sodium hydroxide, potassium hydroxide, or tin (II) chloride.

12. The composition of claim 1, wherein the polycarboxylic acid comprises polyacrylic acid, and wherein the polyacrylic acid has a Mw from 2000-10,000.

13. The composition of claim 1, wherein the polycarboxylic acid comprises polyacrylic acid, and wherein the polyacrylic acid has a Mw from 3000-5000.

14. The composition of claim 1, wherein the polycarboxylic acid comprises polyacrylic acid, and wherein the molar ratio of hydroxyl groups in said polyhydroxy component to carboxylic acid groups in said polyacrylic acid ranges from 0.3:1 to 2:1.

15. A binder composition for fiberglass, comprising a formaldehyde-based binder and a crosslinking agent, wherein the crosslinking agent comprises a polyhydroxy component derived from epoxidized plant oil, wherein the polyhydroxy component is formed from a reaction of an epoxidized plant oil with an amine and optionally with a phenolic compound.

16. The binder composition of claim 15, wherein the formaldehyde-based binder is selected from the group consisting of a phenol-formaldehyde based binder, a urea-formaldehyde based binder, a melamine-formaldehyde based binder, and any combination thereof.

17. A binder composition for fiberglass, comprising a formaldehyde-free binder and a crosslinking agent, wherein the crosslinking agent comprises a polyhydroxy component derived from epoxidized plant oil, wherein the polyhydroxy component is formed from a reaction of an epoxidized plant oil with an amine and optionally with a phenolic compound

18. The binder composition of claim 17, wherein the formaldehyde-free binder is selected from the group consisting of a polyesters, melanoidin-based resin, epoxy resin, acrylic resin, polyurethanes, and any combination thereof.

19. A method of forming a binder composition for fiberglass, comprising:
reacting an epoxidized plant oil with an amine optionally in the presence of a catalyst to form a polyhydroxy crosslinking agent, wherein the molar ratio of the amine to the epoxidized plant oil at the beginning of said reacting step is greater than 0.5:1; and
mixing said polyhydroxy crosslinking agent with a polycarboxylic acid to form the binder composition.

20. A cured binder composition for fiberglass, comprising: (i) a crosslinked polycarboxylic acid, and (ii) a dedusting agent, wherein the dedusting agent comprises a polyhydroxy component formed from a reaction of an epoxidized plant oil with an amine, wherein the molar ratio of the amine to the epoxidized plant oil at the beginning of said reaction is greater than 0.5:1.

21. A fiber-containing composite, comprising:
(a) woven or non-woven fibers; and
(b) a cured binder that holds the fibers together, wherein the binder comprises a polycarboxylic acid crosslinked by a crosslinking agent, wherein the crosslinking agent comprises a polyhydroxy component formed from a reaction of an epoxidized plant oil with an amine, wherein the molar ratio of the amine to the epoxidized plant oil at the beginning of said reaction is greater than 0.5:1.

22. The fiber-containing composite of claim 21, wherein the composite has an onset of exotherm greater than 280° C.

23. The fiber-containing composite of claim 21, wherein the composite has a humid aged dogbone tensile strength greater than 1.1 MPa.

24. A binder composition for fiberglass, comprising a polycarboxylic acid and a crosslinking agent, wherein the crosslinking agent comprises a polyhydroxy component formed from a reaction of an epoxidized plant oil with a phenolic compound and an amine.

25. A method of forming a binder composition for fiberglass, comprising:
reacting an epoxidized plant oil with a phenolic compound and an amine optionally in the presence of a catalyst to form a polyhydroxy crosslinking agent; and
mixing the polyhydroxy crosslinking agent with polyacrylic acid to form the binder composition.

26. The method of claim 25, wherein the molar ratio of the amine to the epoxidized plant oil at the beginning of said reaction is greater than 0.5:1.

27. A cured binder composition for fiberglass, comprising: (i) a crosslinked polycarboxylic acid, and (ii) a dedusting agent, wherein the dedusting agent comprises a polyhydroxy component formed from a reaction of an epoxidized plant oil with a phenolic compound and an amine.

28. A fiber-containing composite, comprising:
(a) woven or non-woven fibers; and
(b) a cured binder that holds the fibers together, wherein the binder comprises a polyacrylic acid crosslinked by a crosslinking agent, wherein the crosslinking agent comprises a polyhydroxy component formed from a reaction of an epoxidized plant oil with a phenolic compound and an amine.

29. The composite of claim 28, wherein less than 1 wt. % of the phenolic compound and less than 1.5% of the amine remain unreacted.
